(19) United States
(12) Patent Application Publication
(10) Pub. No.: US 2017/0315148 A1
(43) Pub. Date: Nov. 2, 2017

(54) SCANNING THERMO-IONIC MICROSCOPY

(71) Applicant: UNIVERSITY OF WASHINGTON THROUGH ITS CENTER FOR COMMERCIALIZATION, Seattle, WA (US)

(72) Inventors: Jiangyu Li, Bellevue, WA (US); Ehsan Nasr Esfahani, Seattle, WA (US); Ahmad Eshghinejad, Santa Clara, CA (US)

(21) Appl. No.: 15/583,107

(22) Filed: May 1, 2017

Related U.S. Application Data
(60) Provisional application No. 62/330,667, filed on May 2, 2016.
(60) Provisional application No. 62/472,901, filed on Mar. 17, 2017.

(51) Int. Cl. G01Q 60/58

(52) U.S. Cl. CPC G01Q 60/58

(57) ABSTRACT

A method of scanning probe microscopy includes supplying heat to a scanning probe. The method also includes receiving a scanning probe deflection signal, where the scanning probe deflection signal is indicative of a magnitude of deflection of the scanning probe when the scanning probe is engaged with a sample. A fourth harmonic signal is separated from the scanning probe deflection signal, and an ionic character of the sample is measured using the fourth harmonic signal.

### REFERENCE TO RELATED APPLICATIONS

This application claims the benefit of U.S. Provisional Application No. 62/330,667, filed on May 2, 2016, and U.S. Provisional Application No. 62/472,901, filed on Mar. 17, 2017, the entire contents of which are hereby incorporated by reference herein.

### STATEMENT AS TO FEDERALLY SPONSORED RESEARCH

This invention was made with government support under Grant No. CBET-1435968, awarded by the National Science Foundation. The government has certain rights in the invention.

### TECHNICAL FIELD

This disclosure relates generally to microscopy, and in particular but not exclusively, relates to scanning probe microscopy.

### BACKGROUND INFORMATION

Electrochemistry is essential for energy conversion and storage in a wide variety of systems including lithium ion batteries, solid oxide fuel cells, supercapacitors, and resistive switching memristors. A growing body of research suggests that electrochemical processes underpinning these applications are largely governed by phenomena occurring at the nanoscale, such as ionic defect formation and transport interfacial chemistry and charge transfer, local cation segregation, and phase nucleation and separation. However, a deep fundamental understanding of these microscopic mechanisms, as well as technological advancement, is largely hampered by a lack of experimental techniques that can directly probe electrochemical processes at the nanoscale. Traditionally, many electrochemical characterization techniques are based on the measurements of current and voltage, which are difficult to scale down to nanometer lengths, as they require detection of small currents on the order of Pico amps that are beyond the capability of conventional charge amplifiers. While scanning electrochemical microscopy (SECM) utilizes custom-made ion-conducting electrodes to study local electrochemistry, it is typically limited to micrometer scales.

Accordingly, there is still room to improve characterization techniques that study the nanometer scale phenomena that underpin the workings of many modern electronic devices.

### BRIEF DESCRIPTION OF THE DRAWINGS

Non-limiting and non-exhaustive examples of the invention are described with reference to the following figures, wherein like reference numerals refer to like parts throughout the various views unless otherwise specified.

FIG. 1 illustrates a scanning probe microscopy system, in accordance with the teachings of the present disclosure.

FIGS. 2A-2B illustrate scanning probes that may be used in the system of FIG. 1, in accordance with the teachings of the present disclosure.

FIG. 3 illustrates a method of scanning probe microscopy, in accordance with the teachings of the present disclosure.

FIG. 4 illustrates a variation on the method of scanning probe microscopy depicted in FIG. 3, in accordance with the teachings of the present disclosure.

FIG. 5 illustrates a scanning probe microscopy imaging system, in accordance with the teachings of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Examples of an apparatus and method for scanning thermo-ionic microscopy (STIM) are described herein. In the following description, numerous specific details are set forth to provide a thorough understanding of the examples. One skilled in the relevant art will recognize; however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one example” or “one embodiment” means that a particular feature, structure, or characteristic described in connection with the example is included in at least one example of the present invention. Thus, the appearances of the phrases “in one example” or “in one embodiment” in various places throughout this specification are not necessarily all referring to the same example. Furthermore, the particular features, structures, or characteristics may be combined in any suitable manner in one or more examples.

The instant disclosure provides systems and methods for separating the deflection signal from a scanning probe microscope into three distinct signals (a first harmonic signal, a second harmonic signal, and a fourth harmonic signal). Each of these signals contains useful information about the sample being imaged: the first harmonic signal may be used to measure an electromechanical response in the sample, the second harmonic signal may be used to measure a thermomechanical response in the sample, and the fourth harmonic signal may be used to probe the ionic characteristics of the sample. To induce the aforementioned responses in the sample, the scanning probe is heated either by passing an electrical current through the scanning probe or by shining a laser (e.g., 405 nm) on the base of the scanning probe. In some examples, all three of these harmonic signals may be measured simultaneously in order to ascertain electromechanical, thermomechanical, and ionic properties of the sample at the same time. This reduces the number of experiments—and researcher time—needed to characterize a new material.

Over the past several years, Vegard strain (i.e., the strain associated with changes in ionic and defect concentrations) has been used to provide an alternative imaging mechanism with high spatial resolution for electrochemical processes. For example, the topography variation of electrode material during charging and discharging of lithium ion batteries has been mapped by atomic force microscopy (AFM), reflecting accumulation of Vegard strain over both space and time. Likewise, electrochemical strain microscopy (ESM) is sensitive to local fluctuation in ionic species and electronic defects, induced by voltage oscillations of a conductive scanning probe tip. However, with all these techniques, it can be difficult to distinguish Vegard strain from other electromechanical mechanisms, such as piezoelectric effect, electrostatic interactions, and capacitive forces. It is also challenging to carry out ESM in operando, due to the possible interference between the scanning probe voltage and any global voltage perturbation applied to the device.

The technique disclosed herein can probe local electrochemistry at the nanoscale, and is termed “scanning thermo-ionic microscopy” (STIM), which is based on imaging of thermally induced Vegard strain. In contrast to ESM, STIM probes the concentration fluctuations of ionic species or electronic defects caused directly or indirectly by temperature oscillation induced by a heated scanning probe. As a result, STIM has several potential advantages over ESM. First, the heated probe is electrically insulated from the sample and thus the measurement is not complicated by other electromechanical mechanisms such as the electrostatic interactions discussed earlier. STIM also easily distinguishes nonlinear strain associated with ionic species and electronic defects from linear thermomechanical sources (such as thermal expansion) due to differences in their harmonic deflection responses. Thus, STIM provides a clean method to probe local ionic activities/defect structure with high sensitivity and spatial resolution that is decoupled from other strain contributions, as well as allowing mapping of local thermomechanical response. This technique can be applied to investigate a wide range of electrochemical systems including electrode materials for lithium ion batteries and solid oxide electrolysis and fuel cells.

Many solids exhibit Vegard strain defined broadly as a lattice volume change associated with a change in the concentration of one or more ionic species or electronic defects. While mechanical deformation is generally not desirable for the operation of lithium ion batteries and other solid state electrochemical devices, such strain provides an alternative imaging mechanism to probe local ionic activities with high spatial resolution. From thermodynamic point of view, Vegard strain induced by concentration changes also suggests a converse effect: that diffusion of ionic and electronic species can be driven by gradients in hydrostatic stress σₕ in addition to gradients in concentration c and electric potential φ. Such a theory has been developed:

$$\frac{\partial c}{\partial t} = ∇ \cdot ( D ∇ c ) + ∇ \cdot ( \frac{DFz}{RT} c ∇ φ ) - ∇ \cdot ( \frac{D Ω}{RT} c ∇ {σ}_{h} ) , \qquad ( 1 )$$

where D, z, and Ω are the diffusivity, charge, and partial molar volume of an ion or defect, F and R are Faraday's constant and the ideal gas constant, and T and t are absolute temperature and time, respectively. Here, we can utilize diffusion driven by the stress gradient (the third term in the equation) for the imaging, which would allow us to overcome a number of difficulties associated with ESM, especially the coupling with other electromechanical contributions.

The most straightforward method of applying local oscillating stress is vibrating the scanning probe mechanically. However, this implementation complicates the measurement of the resulting displacement, and it also severely limits the magnitude of stresses possible. An alternative strategy is to impose stress locally by heating the sample through a thermal probe, passing an AC current through the micro-fabricated resistor localized at the end of the scanning probe, or by shining a laser at the base of the scanning probe to heat the probe. In this method, the thermal probe is heated by a sinusoidal current I[ωt]=I₀ cos [ωt] at an angular frequency ω=2πf. With resistance β, the resulted power dissipation p is given by:

$$p [ 2 ω t ] = β {I}^{2} \approx \frac{{I}_{0}^{2} {β}_{0}}{2} ( 1 + cos [ 2 ω t ] ) \qquad ( 2 )$$

which generates a second harmonic temperature oscillation under the heated probe around average temperature rise ΔT_{DC},

ΔT=ΔT_{DC}+ΔT[2ωt];ΔT[2ωt]=ΔT_{AC} cos [1ωt+θ] (3)

where θ is the phase delay. Such local temperature variation in turn produces a concentrated thermal expansion strain ε* and thus thermal stress σ at the second harmonic,

ε*[2ωt]=αΔT[2ωt]I,σ[2ωt]=C(ε−ε*[2ωt]), (4)

where α and C are the thermal expansion coefficient and stiffness tensor of the material, ε is the total strain consisting of thermal strain and elastic strain, and I is the second rank unit tensor. Now substituting Eq. (4) into (1), and expanding T into Taylor series around averaging temperature T0, we obtain the local concentration oscillation driven by the thermal probe,

$$\frac{\partial c}{\partial t} = - ∇ \cdot ( \frac{D Ω}{{RT}_{0}} ( 1 - \frac{Δ T [ 2 ω ]}{{T}_{0}} ) {c}_{0} ∇ ( \frac{1}{3} tr ( C ( ɛ - αΔ T [ 2 ω t ] I ) ) ) ) . \qquad ( 5 )$$

From Eq. (5), it is evident that the local concentration fluctuation Δc has a second harmonic component as,

$$Δ c [ 2 ω t ] = - ∇ \cdot ( \frac{D Ω}{{RT}_{0}} {c}_{0} ∇ ( \frac{1}{3} tr ( C ( ɛ - αΔ T [ 2 ω t ] I ) ) ) ) , \qquad ( 6 )$$

and a fourth harmonic component as,

$$Δ c [ 4 ω t ] = ∇ \cdot ( \frac{D Ω}{{RT}_{0}^{2}} {c}_{0} Δ T [ 2 ω t ] ∇ ( \frac{1}{3} tr ( C ( ɛ - αΔ T [ 2 ω t ] I ) ) ) ) , \qquad ( 7 )$$

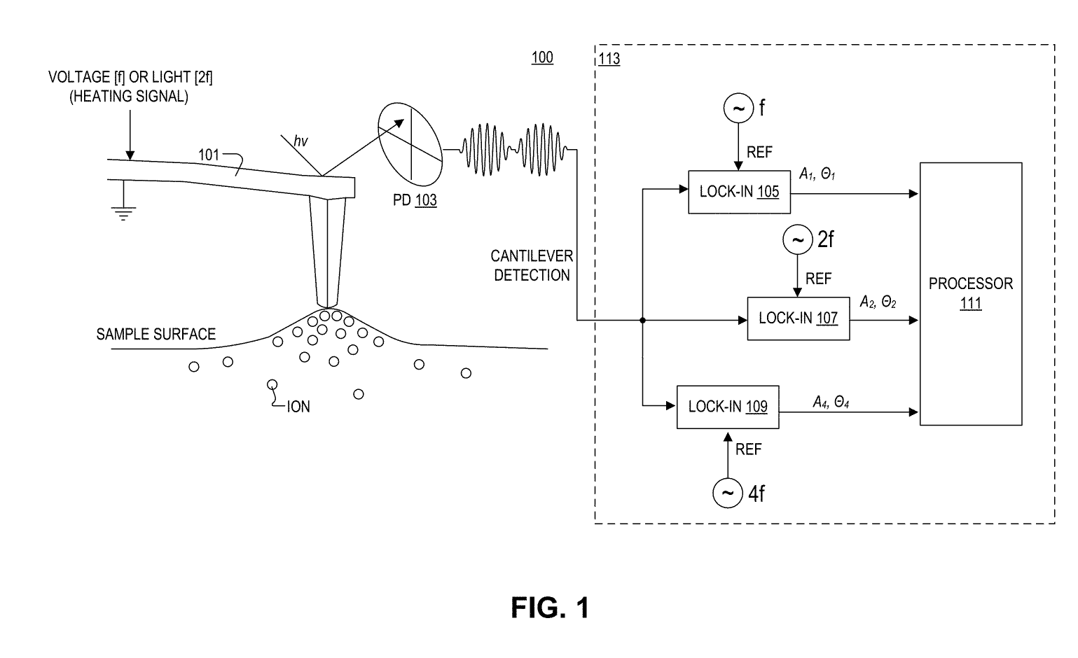

which translate into second and fourth harmonic Vegard strains that can be measured through cantilever vibrations (see e.g., FIG. 1). Note that the second harmonic vibration consists of contributions from both thermal expansion and Vegard strain, as revealed by Eqs. (4) and (6), and it is generally dominated by thermal expansion. However, the fourth harmonic response can only arise from the nonlinear contributions of Vegard strain, and thus can be used to unambiguously detect shifts in ionic and defect concentration. It is this sensitivity of the higher harmonic response to shifts in local concentration that forms the underlying principles of STIM.

It should be noted that the third term in Eq. (1) is only one of possible sources of nonlinear response associated with shifts in concentration. Others not treated here include thermally-induced defect formation and thermally driven transport (Soret/Dufour effects). However, like stress-driven transport, it is expected that strong contributions from these sources will appear in the fourth and higher order harmonic responses, and thus high sensitivity of STIM to local shifts in defect concentration.

The following description will illustrate how these principles can be implemented to create a functioning STIM device.

FIG. 1 illustrates an example STIM system 100, in accordance with the teachings of the present disclosure. STIM system 100 includes scanning probe 101, photodetector 103, and processing apparatus 113 (including lock-in amplifiers 105/107/109 and processor 111). As shown, photodetector 103 is coupled to output a deflection signal to the plurality of lock-in amplifiers, and the lock-in amplifiers are coupled to processor 111. Processor 111 may be a PC, distributed system, internet hosted system, or the like. Processing apparatus 113 includes logic that when executed by processing apparatus 113 causes processing apparatus 113 to perform operations that may be stored in a variety of memories (e.g., RAM, ROM, firmware, or the like). Scanning probe 101 may be included in a commercially available force microscopy system, or may be custom built, in accordance with the teachings of the present disclosure.

As shown scanning probe 101 is coupled to receive a heating signal. In one example, the heating signal is an electrical current passed through scanning probe 101. Alternatively or additionally, local heating and temperature fluctuation in scanning probe 101 can also be realized through a photothermal approach, utilizing a ˜405 nm laser or the like (second light) with modulated intensity aligned at the base of a gold coated cantilever. However, one of ordinary skill in the art will realize there are many ways to heat scanning probe 101 not discussed here, in accordance with the teachings of the present disclosure.

Photodetector 103 (e.g., a photodiode, image sensor, or the like) is coupled to receive a light beam (first light) reflected off of scanning probe 101 to measure the displacement of scanning probe 101 as it passes over the sample surface. The light beam conveys to photodetector 103 a magnitude of deflection of scanning probe 101 when scanning probe 101 is engaged with the sample. For example, if scanning probe 101 passes over a large bump on the surface of the sample, the light beam directed onto scanning probe 101 will be reflected onto photodetector 103 at a different location (depicted in FIG. 1 as quadrants) than if the surface was flat. Similarly, if the sample surface is vibrating in response to the heat transferred from scanning probe 101 (resulting from the heating signal) to the surface of the sample, scanning probe 101 will be similarly deflected and the reflected beam will shine onto a different location of photodetector 103. In the depicted example, the large bump topography of the sample surface will be measured as part of the DC portion of the deflection signal, i.e. the portion of the signal that passes through a low pass filter (f<1500 hz), while the same deflection signal goes through a high pass filter (f>5 kHz) to find the AC (dynamic) portion of deflection for STIM measurements.

Processing apparatus 113 is coupled to photodetector 103 to receive a scanning probe deflection signal (i.e., the electrical signal generated by photodetector 103 in response to receiving the light beam). As stated above, the scanning probe deflection signal contains useful information about ionic surface activity, but also likely contains a lot of noise. Processing apparatus 113 separates the signals from the noise. As shown, to perform this signal processing, processing apparatus 113 may use dedicated lock-in amplifiers that separate the harmonic signals from noise. As one of ordinary skill in the art will appreciate a lock-in amplifier can extract a signal with a known waveform from a noisy environment. In one example, the first harmonic signal, the second harmonic signal and the fourth harmonic signal are extracted from the scanning probe deflection signal with dedicated lock in amplifiers (e.g., lock-in amplifier 105, lock-in amplifier 107, lock-in amplifier 109). The first harmonic signal may be used to measure an electromechanical response in the sample, the second harmonic signal may be used to measure a thermomechanical response in the sample, and the fourth harmonic signal may be used to measure an ionic character of the sample. The ionic character of the sample may include at least one of measuring concentration fluctuations of ionic species in the sample caused by supplying heat to scanning probe 101, or electronic defects in the sample. Moreover, the fourth harmonic signal includes a Vegard strain component, and the Vegard strain component is used to determine the concentration fluctuations of ionic species or the electronic defects in the sample. It is appreciated that processing apparatus 113 may separate/measure all of these harmonic signals at the same time which allows for the user of the system to capture many different types of data simultaneously.

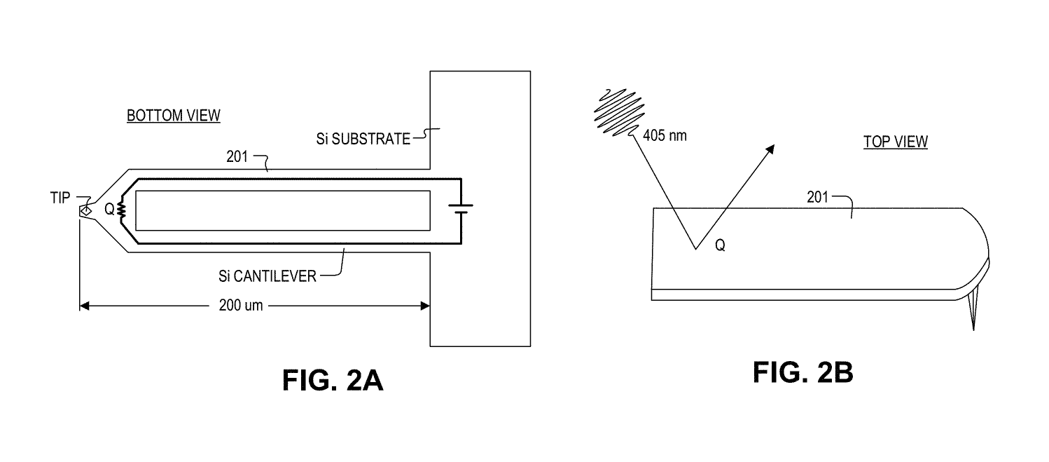

FIGS. 2A-2B illustrate example scanning probes 201 that may be used in the system of FIG. 1, in accordance with the teachings of the present disclosure. As shown FIG. 2A shows a forked scanning probe 201 which includes a micro-fabricated resistor localized at the end of the tip. The bias is applied across the two forks which causes the scanning probe to resistively heat up. The bias may be DC or AC depending on how the user plans to probe the sample surface. Conversely, FIG. 2B depicts a monolithic scanning probe 201. In this example, the processing apparatus may be coupled to a coherent light source to control the light source, and the light source is used to heat scanning probe 201. In the depicted example this is with a 405 nm laser but in other examples light of any other wavelength may be used (e.g., between 375 nm and 450 nm), and scanning probe 201 may be coated with a number of materials to enhance absorption. In some examples, the light may be polarized (e.g., circular polarization) to also induce a current in scanning probe 201.

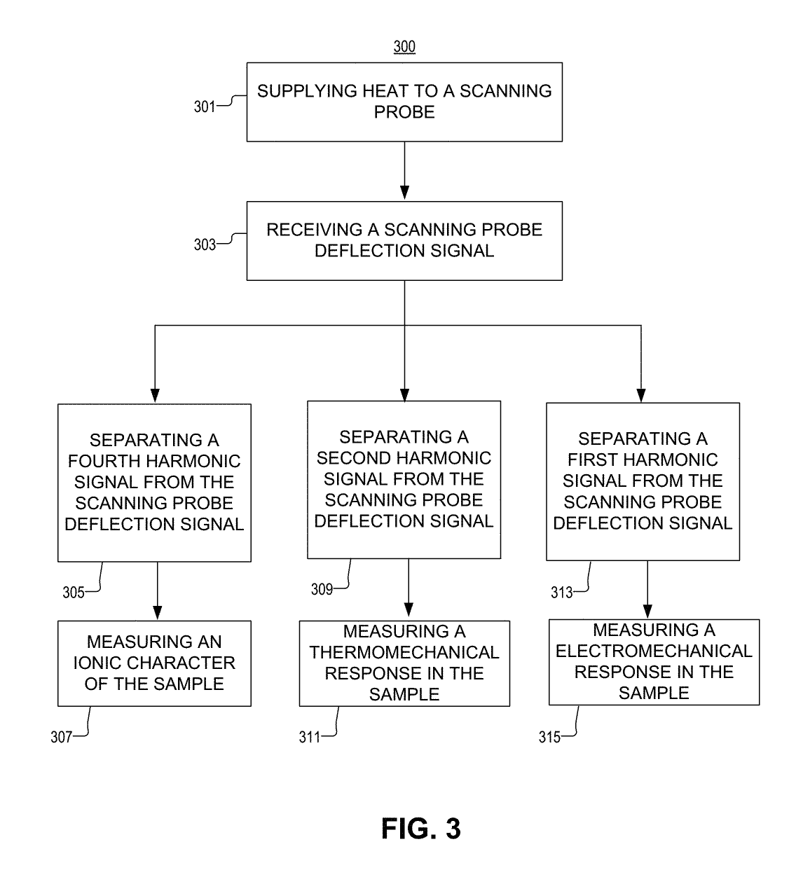

FIG. 3 illustrates an example method 300 of scanning probe microscopy, in accordance with the teachings of the present disclosure. The order in which some or all process blocks appear in method 300 should not be deemed limiting. Rather, one of ordinary skill in the art having the benefit of the present disclosure will understand that some of method 300 may be executed in a variety of orders not illustrated, or even in parallel. Furthermore, method 300 may omit certain process blocks in order to avoid obscuring certain aspects. Alternatively, method 300 may include additional process blocks that may not be necessary in some embodiments/examples of the disclosure.

Process block 301 illustrates supplying heat to a scanning probe. As described above, this may be achieved restively, optically, or the like.

Process block 303 shows receiving a scanning probe deflection signal, where the scanning probe deflection signal is indicative of a magnitude of deflection of the scanning probe when the scanning probe is engaged with a sample. In many cases the deflection signal may be the deflection of a low power laser light reflected off of the scanning probe.

Process block 305 depicts separating a fourth harmonic signal from the scanning probe deflection signal. In some examples this may be with lock-in amplifiers, but on other examples, different forms of signal processing may be used to isolate the fourth harmonic signal.

Process block 307 shows measuring an ionic character of the sample using the fourth harmonic signal. This may include measuring local concentration fluctuations of ionic species in the sample caused by supplying heat to the scanning probe, or electronic defects in the sample. In some examples, the ionic response amplitude may be mapped over the surface of the sample to show the effects of grain boundaries and/or magnetic domains on the ionic character of the surface.

Process block 309 depicts separating a second harmonic signal from the scanning probe deflection signal. As stated this may be achieved with a lock in amplifier in order to accurately remove noise from the signal.

Process block 311 illustrates measuring a thermomechanical response (e.g., the rate of heat transfer from the scanning probe into the sample) in the sample, caused by supplying heat to the scanning probe, using the second harmonic signal. In one example, by measuring the heat transfer, a user may be able to discern the local thermal conductivity of the sample (which may be higher/lower at grain boundaries, defects sites, or the like). One of ordinary skill in the art will appreciate that there may also be a weak ionic response in the second harmonic signal.

Process block 313 shows separating a first harmonic signal from the scanning probe deflection signal

Process block 315 depicts measuring an electromechanical response in the sample, caused by passing an electrical current through the scanning probe, using the first harmonic signal.

As depicted, separating the fourth harmonic signal may occur simultaneously with separating the second harmonic signal, and separating the second harmonic signal may occur simultaneously with separating the first harmonic signal. For example, the thermal response of a polycrystalline material may be characterized with several signals at the same time. If the user elects to analyze the polycrystalline material by looking at the second harmonic signal and fourth harmonic signal, the second harmonic signal may show grain-to-grain variation, as well as variation within a grain, possibly caused by the effect of topography variation on heat transfer between the thermal probe and sample. The ionic response (fourth harmonic signal) on the other hand, may exhibit substantial higher amplitude at the grain boundaries. This contrast may be caused by accumulation of mobile electrons in the diffuse space charge regions near the surface and at grain boundaries. Accordingly, using the STIM techniques discussed the user is able to simultaneously determine many properties of the individual grains in the material.

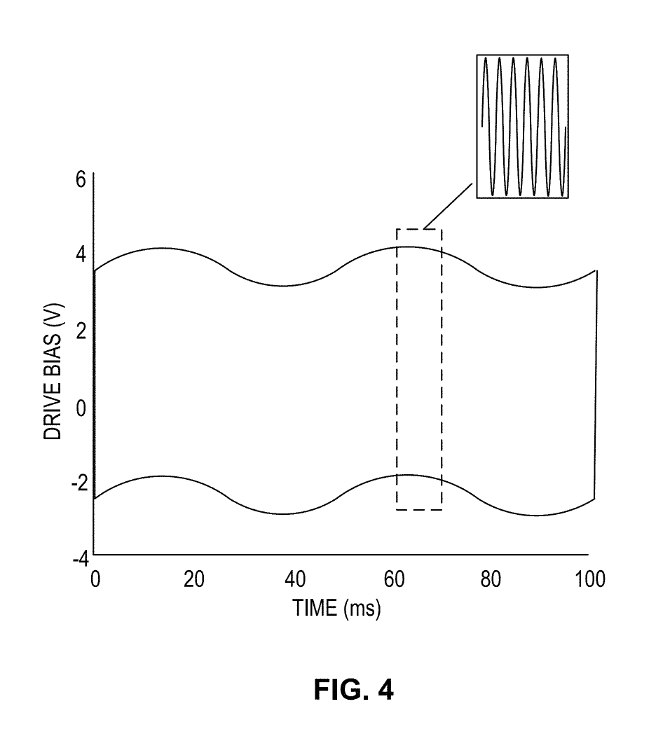

FIG. 4 illustrates a variation on the method of scanning probe microscopy depicted in FIG. 3, in accordance with the teachings of the present disclosure. As shown, the electrical current (heat signal) passed through the scanning probe may be varied by imposing a low frequency modulation bias simultaneously with a high frequency modulation bias. As shown, the high frequency modulation bias has a frequency at least one order of magnitude larger than the low frequency modulation bias.

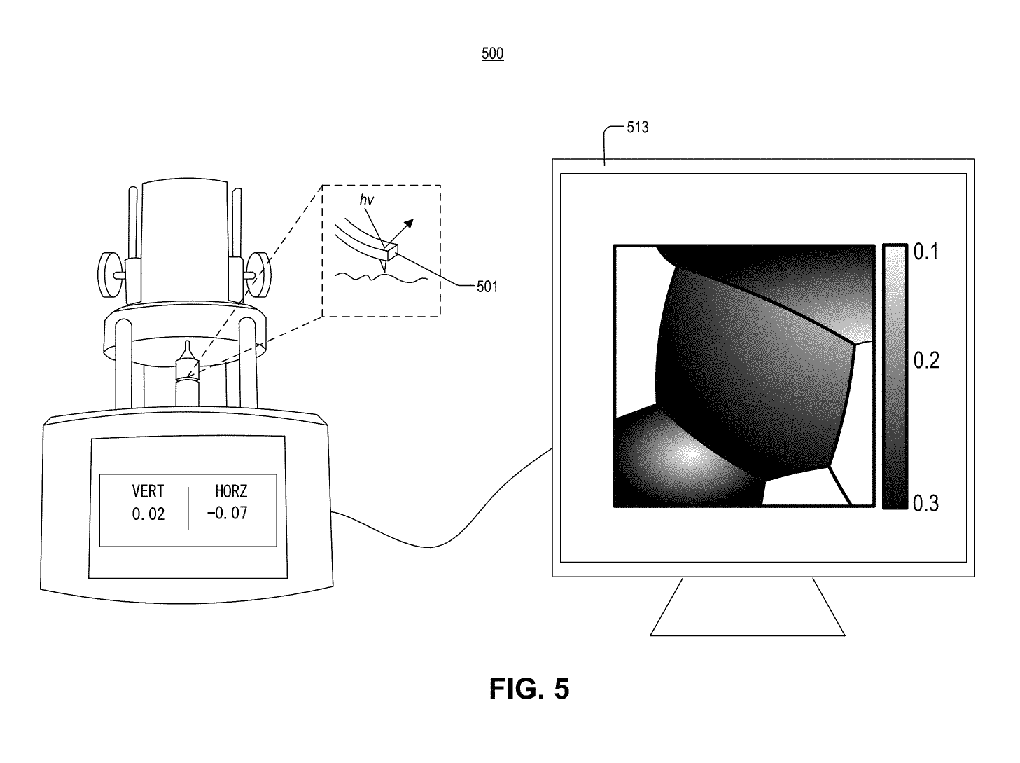

Valuable dynamic information from STIM ionic response can be gleaned by imposing a low-frequency modulation bias, in the range of 0.1 Hz to 20 Hz, on top of high-frequency excitation bias, in the order of 30 kHz, as schematically shown in FIG. 5. The modulation bias is to manipulate the local ionic concentration away from equilibrium by changing the baseline temperature, while excitation bias is to stimulate ionic oscillation for the measurement. Since their frequencies differ by several orders of magnitude, the low-frequency modulation bias can be viewed as DC as far as instantaneous high-frequency excitation bias concerns.

FIG. 5 illustrates an example scanning probe microscopy imaging system 500, in accordance with the teachings of the present disclosure. As shown the STIM system may generate image data of the ionic character of a sample surface, and transmit the data to a display 513. While display 513 only depicts a plot of one type of information that can be obtained from the STIM technique. In other examples the STIM system my output a number of different images, each plotting the surface of the material but with information overlaid (shading/color) about (a) the rate of heat transfer into the sample from the scanning probe (second harmonic), (b) mobility of ions in the sample (fourth harmonic), and/or (c) electromechanical response of the sample (first harmonic) in response to the scanning probe passing over the surface. Thus, localized properties of materials can be accurately measured and constructed into intuitive and aesthetically pleasing plots.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated examples of the invention, including what is described in the Abstract, is not intended to be exhaustive or to limit the invention to the precise forms disclosed. While specific examples of the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific examples disclosed in the specification. Rather, the scope of the invention is to be determined entirely by the following claims, which are to be construed in accordance with established doctrines of claim interpretation.

What is claimed is:

1. A method of scanning probe microscopy, comprising:
supplying heat to a scanning probe;
receiving a scanning probe deflection signal, wherein the scanning probe deflection signal is indicative of a magnitude of deflection of the scanning probe when the scanning probe is engaged with a sample; and
separating a fourth harmonic signal from the scanning probe deflection signal; and
measuring an ionic character of the sample using the fourth harmonic signal.

2. The method of claim 1, wherein measuring the ionic character of the sample includes at least one of measuring concentration fluctuations of ionic species in the sample caused by supplying heat to the scanning probe, or electronic defects in the sample.

3. The method of claim 1, further comprising:
separating a second harmonic signal from the scanning probe deflection signal; and
measuring a thermomechanical response in the sample, caused by supplying heat to the scanning probe, using the second harmonic signal.

4. The method of claim 3, wherein supplying heat to the scanning probe includes passing an electrical current through the scanning probe to resistively heat the scanning probe, wherein the scanning probe includes two discrete columns joined proximate to a tip of the scanning probe.

5. The method of claim 4, further comprising varying the electrical current passed through the scanning probe by imposing a low frequency modulation bias simultaneously with a high frequency modulation bias, wherein the high frequency modulation bias has a frequency at least one order of magnitude larger than the low frequency modulation bias.

6. The method of claim 3, further comprising
separating a first harmonic signal from the scanning probe deflection signal; and
measuring a electromechanical response in the sample, caused by passing an electrical current through the scanning probe, using the first harmonic signal.

7. The method of claim 6, wherein separating the fourth harmonic signal occurs at the same time as separating the second harmonic signal, and wherein separating the second harmonic signal occurs at the same time as separating the first harmonic signal.

8. The method of claim 1, wherein supplying heat to the scanning probe includes illuminating a base of the scanning probe, opposite a tip of the scanning probe, with a beam of light.

9. The method of claim 8, wherein the beam of light has a wavelength between 375 nm and 450 nm.

10. The method of claim 1 further comprising:
generating image data of the ionic character of a surface of the sample; and
transmitting the image data to a display.

11. A scanning probe microscopy system, comprising:
a scanning probe coupled to receive a heating signal;
a photodetector coupled to receive a first light reflected off of the scanning probe, and wherein the first light conveys to the photodetector a magnitude of deflection of the scanning probe when the scanning probe is engaged with a sample; and
a processing apparatus coupled to the photodetector to receive a scanning probe deflection signal generated by the photodetector in response to the photodetector receiving the first light, wherein the processing apparatus includes logic that when executed by the processing apparatus causes the processing apparatus to perform operations including:
separate a fourth harmonic signal from the scanning probe deflection signal; and
measure an ionic character of the sample using the fourth harmonic signal.

12. The system of claim 11, wherein measuring the ionic character of the sample includes at least one of measuring concentration fluctuations of ionic species in the sample caused by supplying heat to the scanning probe, or electronic defects in the sample.

13. The system of claim 11, wherein the fourth harmonic signal includes a Vegard strain component, and wherein the Vegard strain component is used to determine at least one of the concentration fluctuations of ionic species or the electronic defects in the sample.

14. The system of claim 11, wherein the processing apparatus further includes logic that when executed by the processing apparatus causes the processing apparatus to perform operations including:
separate a second harmonic signal from the scanning probe deflection signal; and
measure a thermomechanical response in the sample, caused by supplying the heating signal to the scanning probe, using the second harmonic signal.

15. The system of claim 14, wherein the heating signal is an electrical current passed through the scanning probe.

16. The system of claim 15, wherein the processing apparatus is coupled to the scanning probe, and the processing apparatus further includes logic that when executed by the processing apparatus causes the processing apparatus to perform operations including:
varying the electrical current passed through the scanning probe by imposing a low frequency modulation bias simultaneously with a high frequency modulation bias, wherein the high frequency modulation bias has a frequency at least one order of magnitude larger than the low frequency modulation bias.

17. The system of claim 15, wherein the processing apparatus further includes logic that when executed by the processing apparatus causes the processing apparatus to perform operations including:
separate a first harmonic signal from the scanning probe deflection signal; and
measure an electromechanical response in the sample, caused by passing the electrical current through the scanning probe, using the first harmonic response.

18. The system of claim 17, wherein separating the fourth harmonic signal occurs at the same time as separating the second harmonic signal, and wherein separating the second harmonic signal occurs at the same time as separating the first harmonic signal.

19. The system of claim 18, wherein the processing apparatus includes one more lock-in amplifiers coupled to separate the first harmonic signal, the second harmonic signal, and the fourth harmonic signal from the scanning probe deflection signal.

20. The system of claim 11, wherein the scanning probe is monolithic, and wherein the processing apparatus is coupled to a coherent light source, and wherein the processing apparatus further includes logic that when executed by the processing apparatus causes the processing apparatus to perform operations including:
controlling the coherent light source to emit a second light including the heating signal, wherein the second light is directed proximate to a base of the scanning probe opposite a tip of the scanning probe.
